(19) United States
(12) Patent Application Publication
(10) Pub. No.: US 2025/0209561 A1
(43) Pub. Date: Jun. 26, 2025

(54) CONTEXT-AWARE MATCHING OF PROVIDER DEVICES AND REQUESTER DEVICES BASED ON SHARED CONTEXTUAL CHARACTERISTICS

(71) Applicant: Lyft, Inc., San Francisco, CA (US)

(72) Inventors: Scott David Geller, San Francisco, CA (US); Alyssa Michelle Hitchcock, Bozeman, MT (US); Ding Luo, Seattle, WA (US); Limin Shen, San Francisco, CA (US); Carlisle Alice Uhlman, Brooklyn, NY (US); Yijun Wu, Mountain View, CA (US); Naomi Yarin, Oakland, CA (US); Ohad Zimmerman, New York, NY (US)

(21) Appl. No.: 18/394,793

(22) Filed: Dec. 22, 2023

(51) Int. Cl. G06Q 50/47; G01C 21/34; G01C 21/36; G06Q 10/02

(52) U.S. Cl. CPC G06Q 50/47; G01C 21/3438; G01C 21/3617; G06Q 10/02

(57) ABSTRACT

This disclosure describes one or more embodiments of methods, non-transitory computer-readable media, and systems that utilize computing models to intelligently match provider devices and requester devices in response to context-aware transportation requests. In particular, in one or more embodiments, the disclosed systems utilize a contextual characterization model to identify contextual characteristics of a requester associated with a transportation matching system and provide the requester a selectable option to prioritize transportation matches with providers sharing the identified contextual characteristics. In response to detecting interaction with the selectable option, the disclosed systems can receive and generate contextual transportation matches between the requester device and provider devices associated with providers sharing the identified contextual characteristics.

### BACKGROUND

Recent years have seen significant developments in on-demand transportation systems that utilize mobile devices to coordinate across computer networks. Indeed, the proliferation of web and mobile applications has enabled requesting devices to utilize on-demand ride sharing systems to identify matches between provider devices and requester devices and coordinate across computer networks to initiate transportation from one geographic location to another. For instance, conventional transportation network systems can determine geographic locations of provider devices and requester devices, generate digital matches between provider devices and requester devices, and further track, analyze, and manage pick-up, transportation, and drop-off routines through digital transmissions across computer networks. Although on-demand transportation matching systems can identify requestor devices, select provider devices, dispatch provider devices, and dynamically match requestor devices and provider devices, such systems suffer from a number of technical problems, particularly in flexibility, efficiency, and precision of implementing computer systems.

For instance, conventional systems offer limited flexibility for matching client devices during a transportation request. To illustrate, while conventional systems may allow a provider device to select a particular driving mode, geographic area, or timeframe for responding to transportation requests, such systems generally use rigid factors to make transportation matches between provider and requester devices within these parameters. For instance, conventional systems typically perform a geographic and temporal analysis of available transportation requests from requester devices and available provider devices, then select transportation matches based on these rigid factors.

Additionally, such inflexibility in matching client devices often leads conventional systems to waste computer resources and utilize excessive bandwidth. For example, requester devices faced with a rigid assignment to a particular transportation match will often review details of the transportation match, cancel the corresponding transportation request, and restart a mobile application to submit an additional transportation request in hopes of receiving a more desirable transportation match. Similarly, provider devices faced with a rigid assignment to a particular transportation request will often review details regarding the transportation match, change a mobile application to an offline status (or otherwise submit a cancellation notice for the transportation request), switch the mobile application back to online status (or otherwise restart the mobile application), wait for the system to identify an additional transportation match, and re-evaluate the additional transportation match for compatibility. Also, such inflexibilities in transportation matching can further lead to a degradation in the overall user experience with conventional systems.

Indeed, conventional systems can iteratively repeat these respective processes before a requester device or provider device accepts a transportation match. This not only wastes computer resources of the respective requester or provider device, but backend servers utilize significant computer resources in iteratively managing transportation matches, processing cancellation requests, and reassigning requests across multiple requester and provider devices. Accordingly, conventional systems suffer from inefficient utilization of computing resources (e.g., memory and processing power), excessive bandwidth utilization, and increased latency.

Furthermore, a number of technical barriers exist to providing multiple transportation options to requester devices and/or provider devices in order to prevent network imbalance or other issues. For example, providing a detailed list of optional transportation matches would introduce additional inefficiencies as requester devices or provider devices seek to glean information regarding each transportation match and navigate to other user interfaces to compare the information with transportation details or other information from additional mobile applications. Similarly, providing multiple transportation matches to requester devices and/or provider devices has the potential to introduce overall system inefficiencies as certain transportation matches are repeatedly presented to various respective requester devices or provider devices without taking a transportation request to fulfillment. Similarly, providing multiple transportation matches could lead to inefficiencies and conflicts across requester devices or provider devices that select the same transportation match for fulfillment. Furthermore, the number of available transportation matches for a particular time and region would exhaust and overwhelm the available space of conventional user interfaces and displays.

These, along with additional problems and issues, exist with conventional transportation network systems.

### SUMMARY

This disclosure describes one or more embodiments of methods, non-transitory computer-readable media, and systems that utilize computing models to intelligently match provider devices and requester devices based on shared contextual characteristics between the provider devices and the requester devices. In particular, in one or more embodiments, the disclosed systems provide user interfaces that allow requester devices and/or provider devices to prioritize contextual transportation matches when processing transportation requests. For example, the disclosed systems can determine contextual characteristics of a requester associated with a transportation matching system and provide, to the requester via a requester device, a selectable option to prioritize transportation matches with providers sharing the identified contextual characteristic of the requester. Upon detecting interaction with the selectable option, the disclosed systems can generate contextual transportation matches for transportation requests submitted by the requester device when available. Further, the disclosed systems can provide similar optional features to provider devices for context-aware transportation matching with requester devices.

In one or more implementations, the disclosed systems utilize context-aware transportation matching to intelligently and efficiently manage provider devices to improve the balance of provider devices and requester devices while prioritizing transportation matches between provides and requesters sharing identified contextual characteristics. In this manner, the systems are guided by provider and requester preferences while maintaining threshold ETAs and/or other network balancing metrics to generate flexible, efficient, accurate, and timely transportation matches for requester devices.

Additional features and advantages of one or more embodiments of the present disclosure are outlined in the description as follows, and in part will be obvious from the description, or may be learned by the practice of such example embodiments.

### BRIEF DESCRIPTION OF THE DRA WINGS

The detailed description refers to the drawings briefly described below.

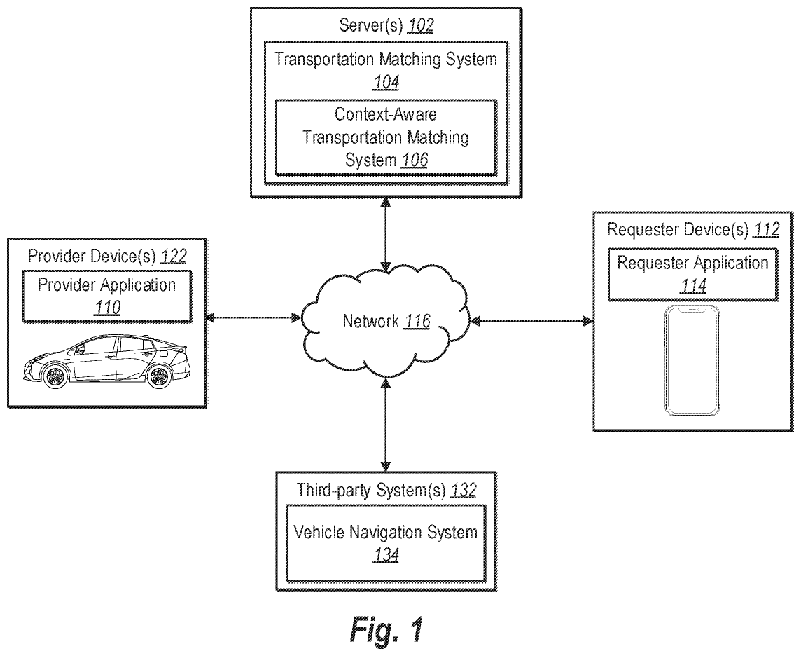

FIG. 1 illustrates a block diagram of an environment for implementing a context-aware transportation matching system in accordance with one or more embodiments.

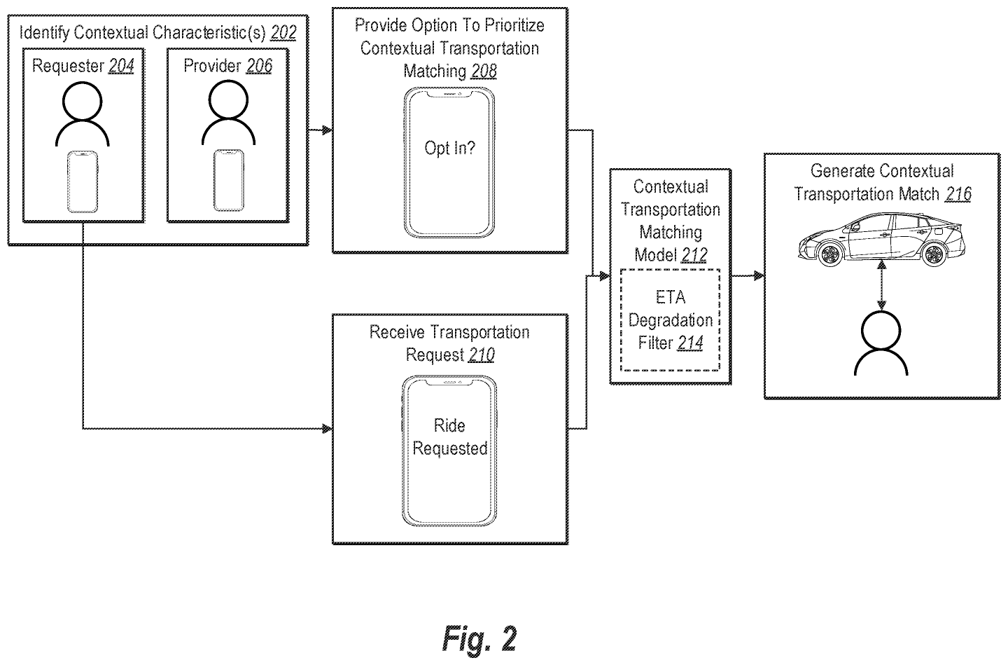

FIG. 2 illustrates an example flow diagram for generating a contextual transportation match between a provider device and requester device in accordance with one or more embodiments.

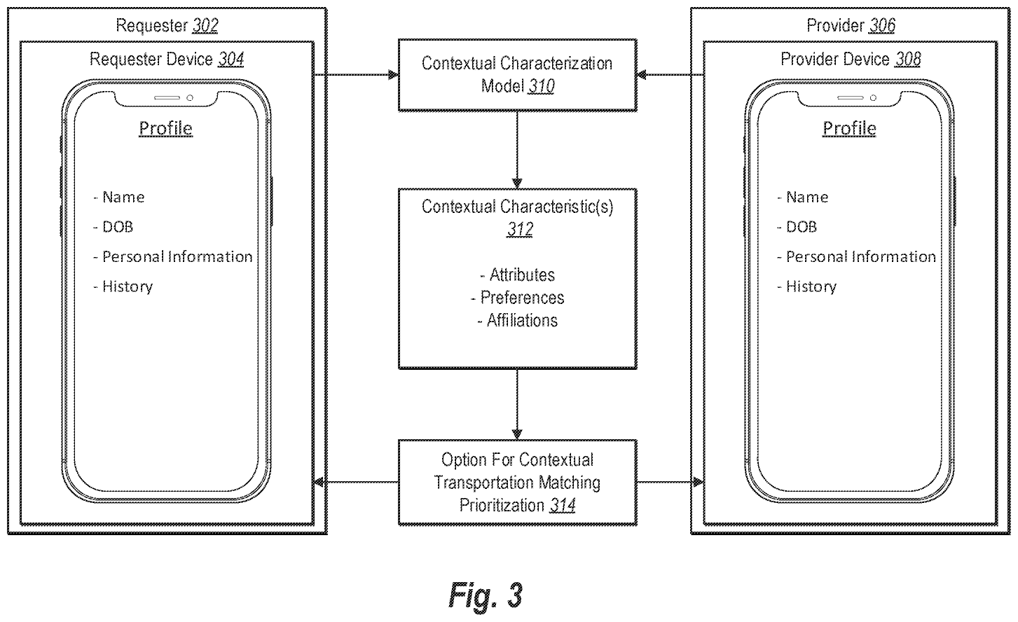

FIG. 3 illustrates the context-aware transportation matching system providing a selectable option for prioritization of contextual transportation matching in accordance with one or more embodiments.

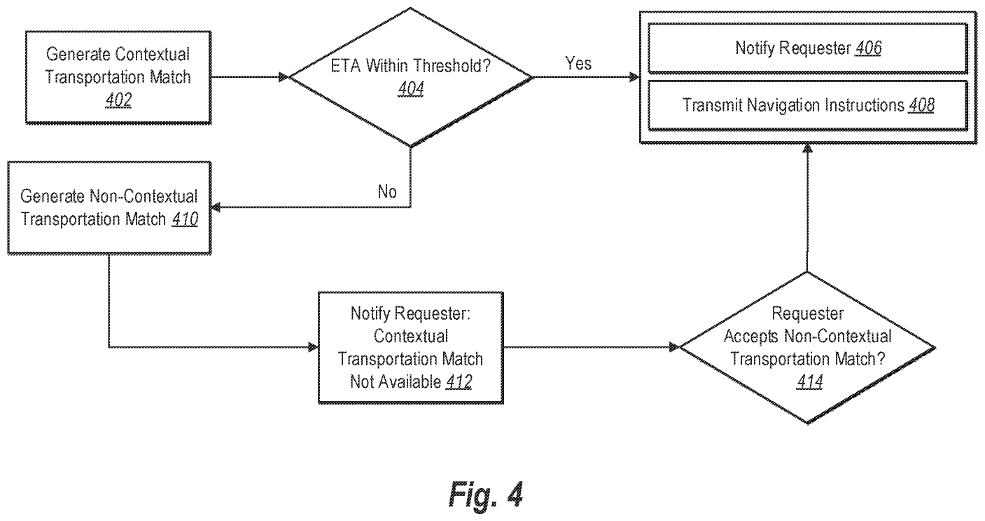

FIG. 4 illustrates an example flow diagram for implementing an ETA degradation filter for contextual transportation matching in accordance with one or more embodiments.

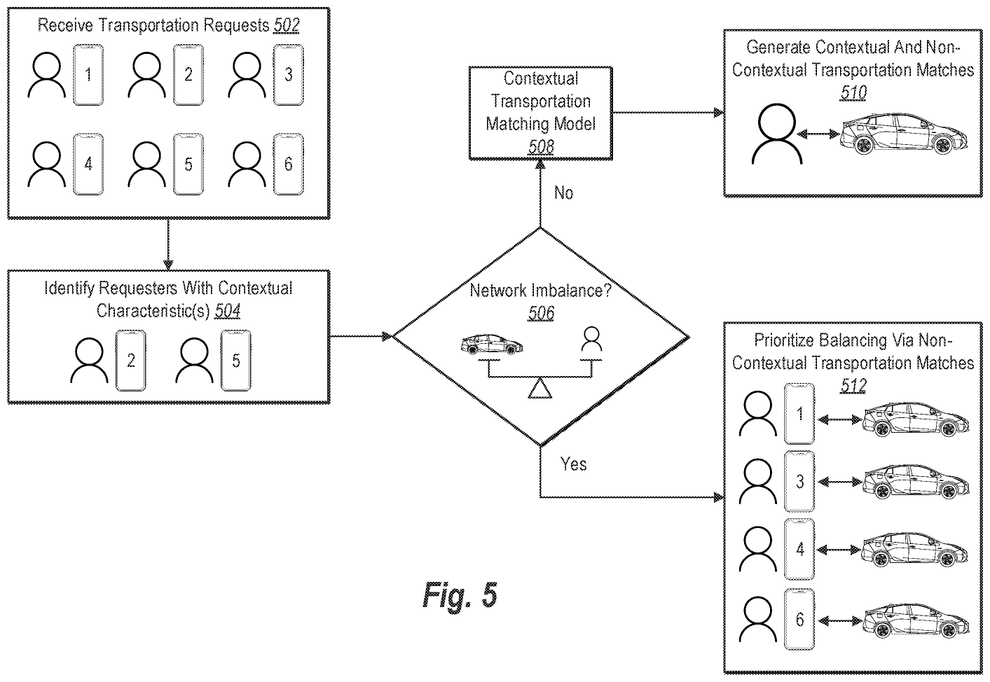

FIG. 5 illustrates an example flow diagram for implementing an efficiency balancing model with contextual transportation matching in accordance with one or more embodiments.

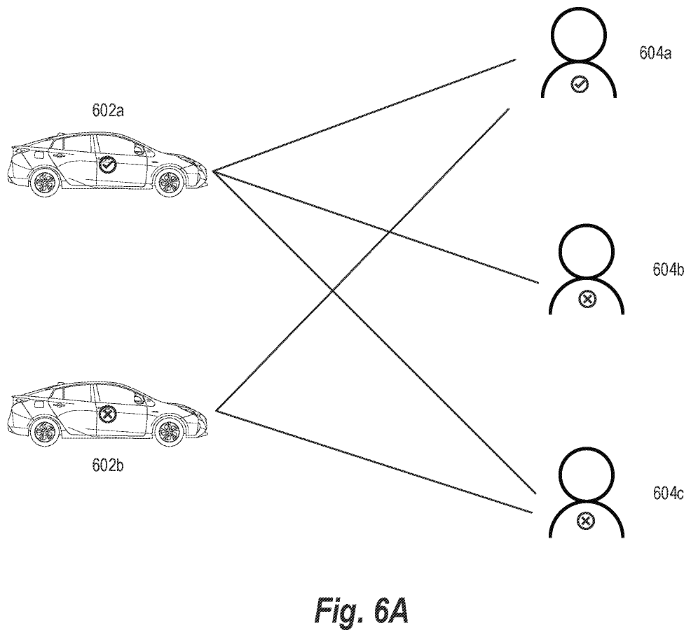

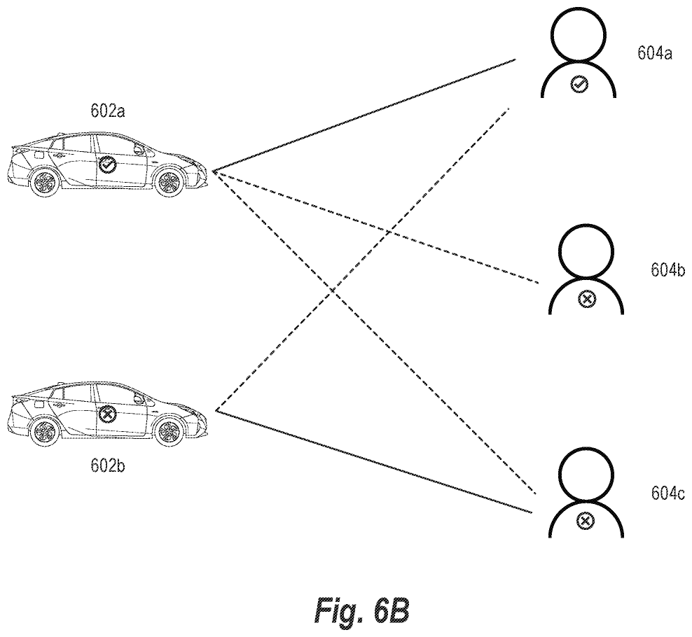

FIGS. 6A-6B illustrate the context-aware transportation matching system generating contextual and non-contextual transportation matches in accordance with one or more embodiments.

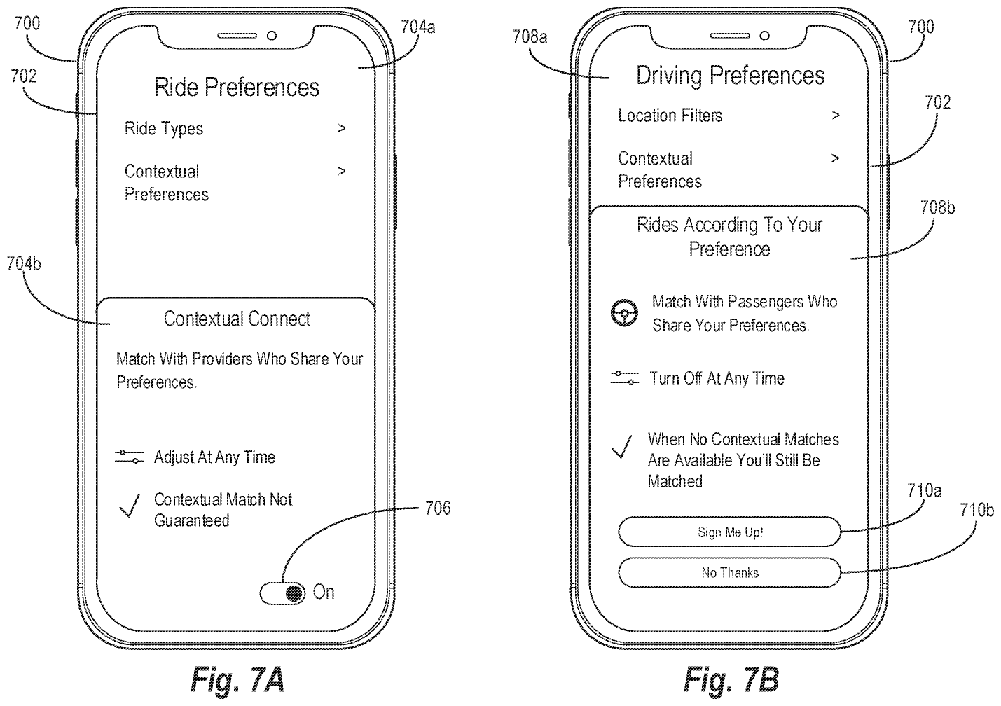

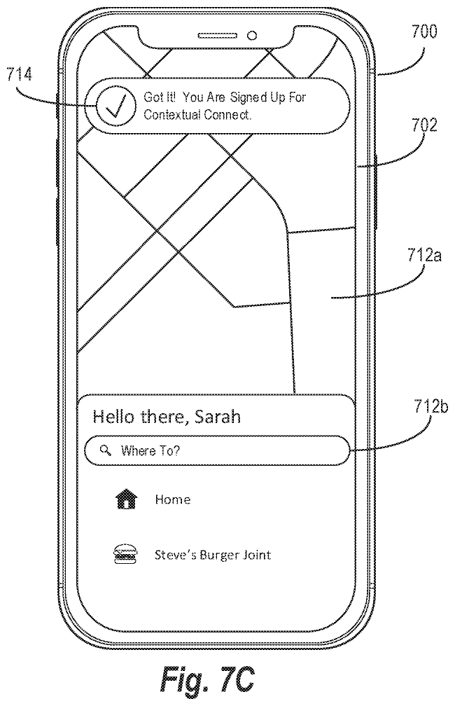

FIGS. 7A-7C illustrate a series of graphical user interfaces for requesting prioritization of contextual transportation matches in accordance with one or more embodiments.

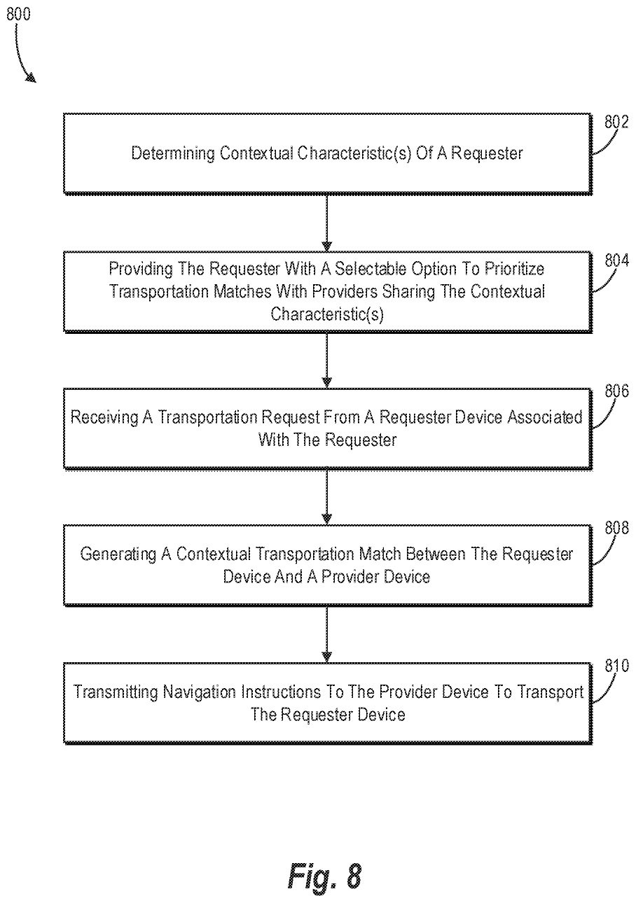

FIG. 8 illustrates an example series of acts for matching a provider device to a requester device based on shared contextual characteristics in accordance with one or more embodiments.

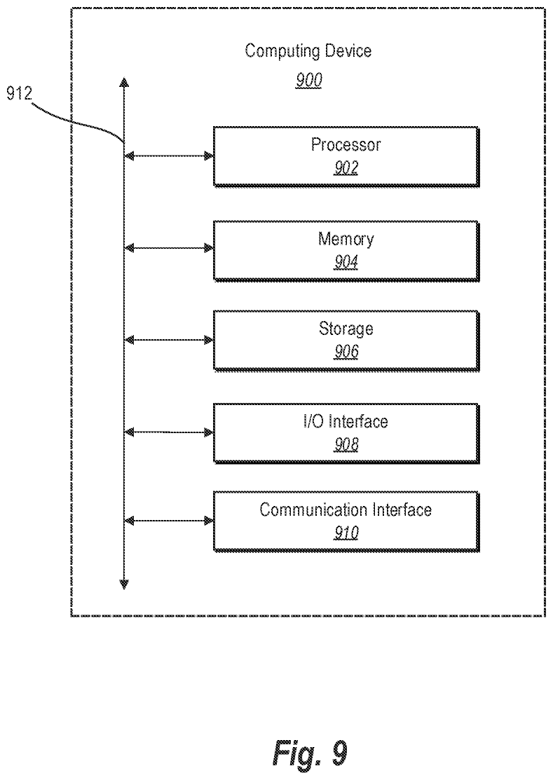

FIG. 9 illustrates a block diagram of a computing device for implementing one or more embodiments of the present disclosure.

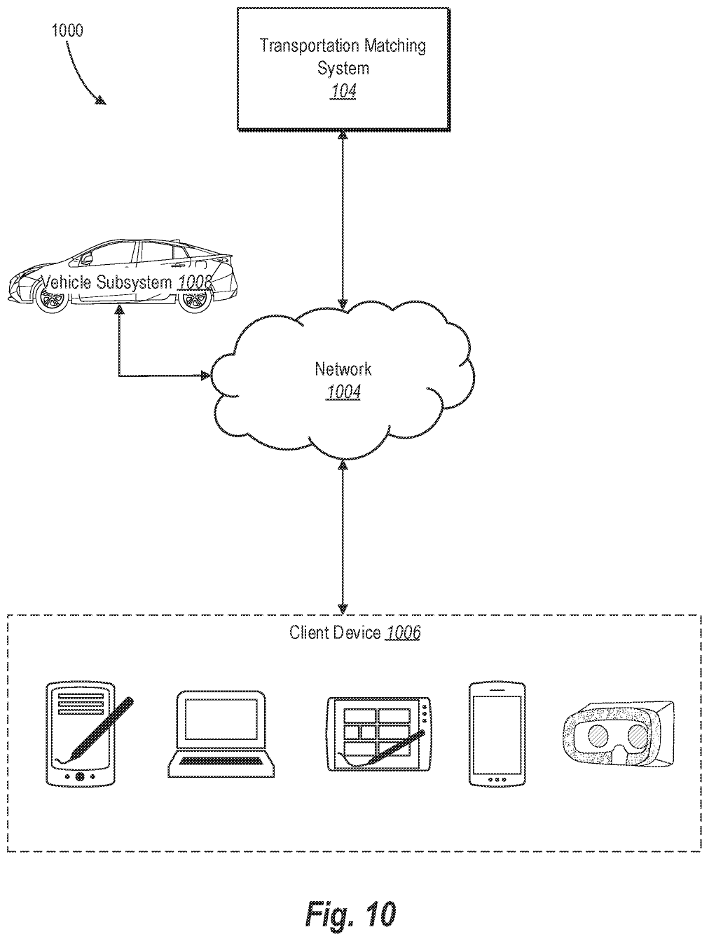

FIG. 10 illustrates an example environment for a transportation matching system in accordance with one or more embodiments.

### DETAILED DESCRIPTION

This disclosure describes one or more embodiments of a context-aware transportation matching system that utilizes computing models to intelligently match provider devices with requester devices based on shared contextual characteristics. In particular, in one or more embodiments, the context-aware transportation matching system provides user interfaces that allow requester devices and/or provider devices to prioritize contextual transportation matches when processing transportation requests. For example, the context-aware transportation matching system can determine contextual characteristics of a requester associated with a transportation matching system and provide, to the requester via a requester device, a selectable option to prioritize transportation matches with providers sharing the identified contextual characteristic of the requester. Upon detecting interaction with the selectable option on the requester device, the context-aware transportation matching system can generate contextual transportation matches for transportation requests submitted by the requester device when available.

Moreover, the context-aware transportation matching system can provide similar optional features to provider devices for context-aware transportation matching with requester devices. In some embodiments, for example, the context-aware transportation matching system identifies contextual characteristics of a provider associated with a transportation matching system and provides, to the provider via a provider device, a selectable option to prioritize transportation matches with requesters sharing the identified contextual characteristics of the provider. Upon detecting interaction with the selectable option on the provider device, the context-aware transportation matching system can generate contextual transportation matches with requesters sharing the identified contextual characteristics when available.

In one or more embodiments, the context-aware transportation matching system utilizes context-aware transportation matching to intelligently and efficiently manage provider devices to improve the balance of provider devices and requester devices while prioritizing transportation matches between providers and requesters sharing identified contextual characteristics. For example, the context-aware transportation matching system can implement an ETA degradation filter for transportation matches, thus requiring that contextual transportation matches meet a predetermined ETA threshold for pickup of the requester device associated with a context-aware transportation request. Moreover, the context-aware transportation matching system can implement an efficiency balancing model to reduce a network imbalance resulting from prioritization of contextual transportation matches over non-contextual transportation matches. In this manner, the systems are guided by provider and requester preferences while maintaining threshold ETAs and/or other network balancing metrics to generate flexible, efficient, accurate, and timely transportation matches for requester devices.

As suggested above, the disclosed context-aware transportation matching system provides several technical improvements or advantages over conventional systems. For instance, the context-aware transportation matching system can improve flexibility and computer functionality relative to conventional systems. Indeed, unlike conventional systems that struggle to identify and generate matches outside of a rigid time-based scheduling scheme, the context-aware transportation matching system can provide transportation matches between requesters and providers based on shared contextual characteristics, such as shared personal attributes, preferences, or affiliations, without interrupting network balance or otherwise degrading efficiency of the overall transportation matching system.

Indeed, the context-aware transportation matching system can implement significantly improved flexibility in providing satisfactory transportation matches between requester devices and provider devices, resulting in a significant decrease in cancellation requests and other user interactions that often degrade network efficiency and overall performance. Further, the context-aware transportation matching system can flexibly decide to apply context-aware transportation matching in consideration of maintaining a network balance between a number of requester devices with pending context-aware transportation requests, a number of provider devices available for contextual matching, and an overall count of available provider devices (regardless of contextual characteristics) and pending transportation requests. Indeed, the context-aware transportation matching system can more accurately and efficiently manage transportation requests across network areas experiencing various combinations of providers and requesters with a variety of preferences for context-aware transportation matching.

By providing context-aware transportation matching according to user preferences, the context-aware transportation matching system provides additional computational efficiencies. For example, by improving the balance between provider devices and requester devices across the network while reducing cancellations of matched transportation requests, the context-aware transportation matching system can significantly improve efficiency of implementing devices/servers. For instance, the context-aware transportation matching system can reduce system resources in communicating with, managing, and matching provider devices and requester devices because the network device balance facilitates more efficient network communications and matching. Indeed, in some implementations, the context-aware transportation matching system reduces the number of requests sent over the network by significantly reducing duplicative matching processes and duplicative notifications to both provider devices and requester devices. Thus, the context-aware transportation matching system can reduce utilization of computing resources (e.g., processing power and/or memory) and improve network bandwidth.

As indicated by the foregoing discussion, the present disclosure utilizes a variety of terms to describe features and advantages of the context-aware transportation matching system. For example, as used herein, the term “provider device” refers to a computing device associated with a transportation provider or driver (e.g., a human driver or an autonomous computer system driver) that operates a transportation vehicle. For instance, a provider device refers to a mobile device such as a smartphone or tablet operated by a provider—or a device associated with an autonomous vehicle that drives along transportation routes.

As suggested above, the term “requester device” refers to a computing device associated with a requester that submits a transportation request to a transportation matching system. For instance, a requester device receives interaction from a requester in the form of user interaction to submit a transportation request. After the transportation matching system matches a requester (or a requester device) with a provider (or a provider device), the requester can await pickup by the provider at a predetermined pick-up location. Upon pick-up, the provider transports the requester to a drop-off location specified in the requester's transportation request. Accordingly, a requester may refer to (i) a person who requests a request or other form of transportation but who is still waiting for pickup, (ii) a person who requests a request or other form of transportation for another person, or (iii) a person whom a transportation vehicle has picked up and who is currently riding within the transportation vehicle to a drop-off location.

As used herein, the term “transportation request” refers to a request from a requesting device (i.e., a requester device) for transport by a transportation vehicle. In particular, a transportation request includes a request for a transportation vehicle to transport a requester or a group of individuals from one geographic area to another geographic area. A transportation request can include information such as a pick-up location, a destination location (e.g., a location to which the requester wishes to travel), a request location (e.g., a location from which the transportation request is initiated), location profile information, a requester rating, or a travel history. As an example of such information, a transportation request may include an address as a destination location and the requester's current location as the pick-up location. A transportation request can also include a requester device initiating a session via a transportation matching application and transmitting a current location (thus, indicating a desire to receive transportation services from the current location).

Relatedly, as used herein, the term “context-aware transportation request” refers to a transportation request initiated by a requester device that has selected an option to prioritize contextual transportation matches when submitting transportation requests. As used herein, a “contextual transportation match” refers to a transportation match between a requester device and a provider device associated with a respective requester and provider sharing at least one contextual characteristic (identified and considered by the context-aware transportation matching system). As used herein, “contextual characteristics” refer to characteristics of a requester or provider associated with a transportation matching system which can be utilized in providing contextual transportation matches in response to context-aware transportation requests. For example, contextual characteristics can include one or more characteristics comprising attributes (e.g., gender at birth or gender identity), preferences (e.g., a preferred genre of music), or affiliations (e.g., a geographical or organizational affiliation). Thus, to illustrate, the context-aware transportation matching system can match drivers and providers having a shared hometown (or other common location history), a shared education (e.g., a mutual college or high school), a shared work place, a shared gender, a shared sports team. In one or more implementations, contextual characteristics include information extracted from a user profile.

Further, as used herein, the term “pool of available provider devices” refers to a group or set of provider devices available to be matched with requester devices. In particular, the pool of available provider devices can include unmatched provider devices or provider devices predicted to be available (e.g., within a threshold time or within a threshold distance).

Relatedly, as used herein, the term “provider device requester device balance metric” refers to a measure of a balance between provider devices and requester devices. In particular, a provider device requester device balance metric includes a metric indicating the number of available provider devices relative to requester devices. For example, a high number of excess provider devices relative to requester devices can reflect a high provider device requester device balance metric. Similarly, a high number of excess requester devices relative to provider devices can reflect a low provider device requester device balance metric.

Additional detail regarding the context-aware transportation matching system will now be provided with reference to the figures. In particular, FIG. 1 illustrates a block diagram of a system environment for implementing a context-aware transportation matching system 106 in accordance with one or more embodiments. As shown in FIG. 1, the environment includes server(s) 102 housing the context-aware transportation matching system 106 as part of a transportation matching system 104. The environment of FIG. 1 further includes a provider device(s) 122 (including a provider application 110) and a requester device(s) 112 (including a requester application 114), as well as a network 116. The server(s) 102 can include one or more computing devices to implement the context-aware transportation matching system 106. The environment of FIG. 1 further includes a third-party system(s) 132 (including a vehicle navigation system 134). Additional detail regarding the illustrated computing devices (e.g., the server(s) 102, the provider device(s) 122, the requester device(s) 112, and/or the third-party system(s) 132) is provided with respect to FIGS. 9-10 below.

As shown, the context-aware transportation matching system 106 utilizes the network 116 to communicate with the provider device(s) 122 and the requester device(s) 112. The network 116 may comprise any network described in relation to FIGS. 9-10. For example, the context-aware transportation matching system 106 communicates with the provider device(s) and the requester device(s) 112 to match transportation requests received from the requester device(s) 112 with the provider device(s) 122. Indeed, the transportation matching system 104 or the context-aware transportation matching system 106 can receive a transportation request from the requester device(s) 112 and can provide request information to various provider devices, such as a requested location (e.g., a requested pickup location and/or a requested drop-off location), a requester identification (e.g., for a requester corresponding to the requester device(s) 112), and an indication of whether a requester or provider has elected to prioritize contextual transportation matches. In some embodiments, per device settings, the transportation matching system 104 or the context-aware transportation matching system 106 receives device information from various provider devices and the requester device(s) 112, such as location coordinates (e.g., latitude, longitude, and/or elevation), orientations or directions, motion information, and indications of user interactions with various interface elements.

To facilitate connecting transportation requests with transportation vehicles, in some embodiments, the transportation matching system 104 or the context-aware transportation matching system 106 communicates with the provider device(s) 122 and other provider devices (e.g., through a provider application 110). As indicated by FIG. 1, the provider device(s) 122 includes the provider application 110. In many embodiments, the transportation matching system 104 or the context-aware transportation matching system 106 communicates with the provider device(s) 122 through the provider application 110 to, for example, receive and provide information including location data, motion data, transportation request information (e.g., pickup locations and/or drop-off locations), and transportation route information for navigating to one or more designated locations. Further, in some embodiments, the context-aware transportation matching system 106 communicates with the provider device(s) 122 through the provider application 110 to determine one or more contextual characteristics of the provider(s) associated with the provider device(s) 122 and, in response, provide a selectable option to prioritize contextual transportation matches with the provider device(s) 122.

Similarly, the transportation matching system 104 or the context-aware transportation matching system 106 communicates with the requester device(s) 112 (e.g., through the requester application 114) to facilitate connecting requests with transportation vehicles. In many embodiments, the context-aware transportation matching system 106 communicates with the requester device(s) 112 through the requester application 114 to, for example, receive and provide information including location data, motion data, transportation request information (e.g., requested locations), and navigation information to guide a requester to a designated location. Further, in some embodiments, the context-aware transportation matching system 106 communicates with the requester device(s) 112 through the requester application 114 to determine one or more contextual characteristics of the requester(s) associated with the requester device(s) 112 and, in response, provide a selectable option to prioritize contextual transportation matches for transportation requests initiated by the respective requester device(s) 112.

As indicated above, the transportation matching system 104 or the context-aware transportation matching system 106 can provide (and/or cause the provider device(s) 122 to display or render) visual elements within a graphical user interface associated with the provider application 110 and the requester application 114. For example, the transportation matching system 104 or the context-aware transportation matching system 106 can provide a digital map for display on the provider device(s) 122 that illustrates a transportation route to navigate to a designated location. The context-aware transportation matching system 106 can also provide a transportation request notification for display on the provider device(s) 122 indicating a transportation request.

Moreover, as illustrated the context-aware transportation matching system 106 provides a user interface via the requester device(s) 112 that includes selectable options for various types of transportation requests (e.g., a standard transportation request, a context-aware transportation request). To illustrate, the selectable option for a context-aware transportation request can include additional detail about contextual matching, such as the contextual characteristics upon which the contextual matching is based, and a notification that contextual matches will be prioritized and implemented when available. Also, in some embodiments, further selectable options can include an option to accept or deny a non-contextual transportation match (e.g., a match generated without consideration of a particular shared characteristic) when a contextual match is not available.

Although FIG. 1 illustrates the environment having a particular number and arrangement of components associated with the context-aware transportation matching system 106, in some embodiments, the environment may include more or fewer components with varying configurations. For example, in some embodiments, the transportation matching system 104 or the context-aware transportation matching system 106 can communicate directly with the provider device(s) 122 and/or the requester device(s) 112, bypassing the network 116. In these or other embodiments, the transportation matching system 104 or the context-aware transportation matching system 106 can be housed (entirely on in part) on the provider device(s) 122 and/or the requester device(s) 112. Additionally, the transportation matching system 104 or the context-aware transportation matching system 106 can include or communicate with a database for storing information, such as various machine learning models, historical data (e.g., historical provider device and/or requester device patterns), transportation requests, and/or other information described herein.

As mentioned previously, in one or more embodiments, the context-aware transportation matching system 106 generates contextual transportation matches between requester devices and provider devices associated with respective requesters and providers that share one or more contextual characteristics. For example, FIG. 2 illustrates an example sequence flow for generating a contextual transportation match between a requestor and a provider that share one or more identified contextual characteristics.

Specifically, FIG. 2 illustrates the context-aware transportation matching system 106 generating, in response to a context-aware transportation request, a contextual transportation match between a requester device and a provider device respectively associated with a requester 204 and a provider 206 which share one or more previously identified contextual characteristics. As shown in FIG. 2, for instance, the context-aware transportation matching system 106 performs an act 202 of identifying contextual characteristic(s) of the requester 204 and the provider 206. In some embodiments, for example, the context-aware transportation matching system 106 identifies and designates one or more contextual characteristics for generating contextual transportation matches, such as attributes, preferences, and/or affiliations shared between at least some requesters and providers associated with (e.g., having an account or otherwise registered with) a transportation matching system, such as the transportation matching system 104.

As also shown in FIG. 2, having determined that the requester 204 and/or the provider 206 have (or otherwise associate with) at least one of the contextual characteristics designated for contextual transportation matching, the context-aware transportation matching system 106 performs an act 208 of providing the requester 204 and/or the provider 206 with an option to prioritize contextual transportation matching. As shown, the context-aware transportation matching system 106 provides the selectable option prior to receiving, at an act 210, a transportation request from the requester device of the requester 204. In some implementations, the context-aware transportation matching system 106 provides the selectable option upon receipt of the transportation request from the requester device of the requester 204. Similarly, the context-aware transportation matching system 106 can provide the selectable option to a provider device associated with the provider 206 prior to initiation of transportation matching or upon detecting a potential match with a context-aware transportation request.

After receiving, at act 210, a context-aware transportation request from the requester device associated with the requester 204, the context-aware transportation matching system 106 utilizes a contextual transportation matching model 212 to generate, at act 216, a contextual transportation match (e.g., between the requester device of the requester 204 and the provider device of the provider 206). As shown in FIG. 2, the contextual transportation matching model 212 includes an ETA degradation filter 214. In some embodiments, for example the context-aware transportation matching system 106 prioritizes contextual transportation matches for context-aware transportation requests while maintaining a threshold ETA for arrival of matched provider devices at respective pickup locations (e.g., as described below in relation to FIG. 4).

As mentioned previously, in one or more embodiments, the context-aware transportation matching system 106 provides a selectable option to requesters and/or providers for prioritization of contextual transportation matching. To further illustrate, FIG. 3 depicts the context-aware transportation matching system 106 identifying one more contextual characteristics of a requester and a provider associated with a transportation matching system and providing a selectable option for prioritizing contextual transportation matches.

As shown in FIG. 3, the context-aware transportation matching system 106 utilizes a contextual characterization model 310 to determine one or more contextual characteristics 312 of a requester 302. In some embodiments, for example, the contextual characterization model 310 analyzes information associated with the requester 302, such as user profile information provided by the requester 302 via a requester device 304, to determine the one or more contextual characteristics 312 for context-aware transportation matching. As shown, the contextual characteristics 312 can include attributes, preferences, or affiliations of the requester 302. In some embodiments, the context-aware transportation matching system 106 can designate one or more contextual characteristics based on a survey of requesters and providers across a variety of geographic areas. Alternatively or additionally, the requesters and providers associated with a transportation matching system can voluntarily request contextual matching according to one or more personal contextual characteristics.

As also shown in FIG. 3, the context-aware transportation matching system 106 provides the requester 302 (e.g., via the requester device 304) with an option for contextual transportation matching prioritization 314. Accordingly, the requester 302 can elect to prioritize transportation matches with providers sharing the contextual characteristic(s) 312 in response to subsequent transportation requests submitted by the requester 302 via the requester device 304 (or another requester device associated with the requester 302).

Similarly, as shown in FIG. 3, the context-aware transportation matching system 106 utilizes the contextual characterization model 310 to determine one or more contextual characteristics 312 of a provider 306. In some embodiments, for instance, the context-aware transportation matching system 106 utilizes the contextual characterization model 310 to determine contextual characteristics 312 based on information provided by the provider 306 (e.g., via a provider device 308). As with the requester 302, the context-aware transportation matching system 106 provides the provider 306 (e.g., via the provider device 308) with the option for contextual transportation matching prioritization 314. Accordingly, the provider 306 can elect to prioritize transportation matches with transportation requests submitted by requesters sharing the contextual characteristic(s) 312 of the provider 306, as identified by the contextual characterization model 310.

As mentioned previously, in one or more embodiments, the context-aware transportation matching system 106 implements an ETA degradation filter for contextual transportation matching. For example, FIG. 4 illustrates an example sequence flow for implementing an ETA degradation filter when providing a transportation match in response to a context-aware transportation request.

As shown in FIG. 4, the context-aware transportation matching system 106 performs an act 402 of generating a contextual transportation match for a context-aware transportation request received from a requester device. Then, the context-aware transportation matching system 106 performs an act 404 of determining whether the generated contextual transportation match comprises an ETA (e.g., an expected arrival of a corresponding provider device at a pickup location indicated within the context-aware transportation request) within a predetermined threshold ETA (e.g., a maximum acceptable waiting period set by the transportation matching system).

Upon determining, at the act 404, that the generated contextual transportation match comprises an ETA within the threshold ETA, the context-aware transportation matching system 106 performs an act 406 of notifying the requester (e.g., via a requester device) of the contextual transportation match with a provider device associate with a provider sharing contextual characteristics with the provider. Then, in response to determining that the requester has accepted the contextual transportation match, the context-aware transportation matching system 106 performs an act 408 of transmitting navigation instructions to the provider device for transporting the requester device from a pickup location indicated in the context-aware transportation request.

Alternatively, upon determining, at act 404, that the generated contextual transportation match does not include an ETA within the threshold ETA, the context-aware transportation matching system 106 performs an act 410 of generating a non-contextual transportation match for the context-aware transportation request (e.g., a transportation match comprising an ETA within the threshold ETA). In some embodiments, for example, a non-contextual transportation match comprises a transportation match between the requester device and a provider device associated with a provider that does not share a contextual characteristic or is generated/determined without prioritizing a shared contextual characteristic. Indeed, in some implementations, the matched provider of a non-contextual transportation match may actually share the contextual characteristics of the requester (e.g., a provider which has not elected to prioritize contextual transportation matching despite sharing the contextual characteristics).

Further, as shown in FIG. 4, the context-aware transportation matching system 106 performs an act 412 of notifying the requester (e.g., via the requester device) that a contextual match is not available for the context-aware transportation request. As shown, the context-aware transportation matching system 106 further provides, at an act 414, the requestor with a selectable option to proceed with a non-contextual transportation match prior to generating the non-contextual transportation match. Alternatively, in some embodiments, the context-aware transportation matching system 106, upon determining that a contextual transportation match is not available for the context-aware transportation request, automatically generates a non-contextual transportation match and present the match to the requester with an indication that the match is not contextual.

As shown in FIG. 4, upon determining that the requester accepts non-contextual matching for the transportation request, the context-aware transportation matching system 106 performs the act 406 of notifying the requester (e.g., via the requester device) of the non-contextual transportation match. Then, in response to determining that the requester has accepted the non-contextual transportation match generated at act 410, the context-aware transportation matching system 106 performs the act 408 of transmitting navigation instructions to the provider device for transporting the requester device from the pickup location indicated in the context-aware transportation request.

As mentioned previously, in one or more embodiments, the context-aware transportation matching system 106 implements an efficiency balancing model for context-aware transportation matching. For example, FIG. 5 illustrates an example sequence flow for implementing an efficiency balancing model for contextual and non-contextual transportation matching in response to a plurality of transportation requests comprising both contextual and non-contextual transportation requests.

As shown in FIG. 5, the context-aware transportation matching system 106, at an act 502, receives a plurality of transportation requests (e.g., transportation requests 1 through 6). In response to receiving the plurality of transportation requests, the context-aware transportation matching system 106 performs an act 504 of identifying transportation requests from requester devices associated with requesters having contextual characteristic(s) designated for contextual matching. In some embodiments, the act 504 comprises identifying context-aware transportation requests (e.g., requests corresponding to requesters which have elected to prioritize contextual transportation matches) among the plurality of received transportation requests. As shown in FIG. 5, for example, the context-aware transportation matching system 106 identifies the transportation requests 2 and 5 as context-aware transportation requests.

Then, in response to identifying the context-aware transportation requests within the plurality of transportation requests received, the context-aware transportation matching system 106 performs an act 506 of determining whether the transportation matching system is experiencing a network imbalance. In some embodiments, for example, the context-aware transportation matching system 106 monitors one or more network balancing metrics, such as a provider device requester device balance metric, to proactively track the network balance of the transportation matching system during the context-aware transportation matching process.

Moreover, in response to determining an acceptable measure of network imbalance (or a lack of network imbalance below a threshold ratio), the context-aware transportation matching system 106 utilizes a contextual transportation matching model 508 to perform an act 510 of generating contextual transportation matches for the identified context-aware transportation requests of the plurality of transportation requests and additionally generates non-contextual transportation matches for the respective non-contextual transportation requests of the plurality of transportation requests.

Alternatively, in response to identifying a network imbalance (e.g., an imbalance between a number of transportation requests and a number of available provider devices above a threshold ratio), the context-aware transportation matching system 106 performs an act 512 of prioritizing efficiency balancing via non-contextual transportation matches. For example, the context-aware transportation matching system 106 can generate transportation matches according to a queue of the plurality of transportation requests, regardless of contextual characteristics, in order to improve availability of provider devices across transportation requests.

As mentioned previously, the context-aware transportation matching system 106 can intelligently generate contextual transportation matches and non-contextual transportation matches for transportation requests under a variety of circumstances. For example, FIGS. 6A-6B illustrate the context-aware transportation matching system 106 generating contextual transportation matches and non-contextual transportation matches according to various circumstantial priorities. In particular, FIGS. 6A-6B show the context-aware transportation matching system 106 generating transportation matches between a group of provider devices and requester devices comprising: a first provider device 602a designated for context-aware transportation matching, a second provider device 602b not designated for context-aware transportation matching, a first requester device 604a designated for context-aware transportation matching, and a second requester device 604b and a third requester device 604c not designated for context-aware transportation matching.

As shown in FIG. 6A, the context-aware transportation matching system 106, in certain implementations (e.g., in response to detecting a network imbalance, as described above in relation to FIG. 5), generates transportation matches regardless of contextual or non-contextual statuses of the respective provider devices 602a-602b and requester devices 604a-604c. As illustrated, for example, the context-aware transportation matching system 106 determines that the provider device 602a is available to fulfill transportation matches with any of the requester devices 604a-604c. In contrast, the context-aware transportation matching system 106 determines that the provider device 602b is only available to fulfill a transportation match with either the requester device 604a or the requester device 604c (e.g., due to limitations in time, size, or other transportation factors relative to the provider device 602b). Accordingly, the context-aware transportation matching system 106 can match the provider device 602a with transportation requests from any of the requester devices 604a-604c, while limiting matches provided to the provider device 602b to transportation requests from either the requester device 604a or 604c.

As shown in FIG. 6B, the context-aware transportation matching system 106, in certain implementations (e.g., context-aware matching in the absence of a significant network imbalance), prioritizes a contextual transportation match between the provider device 602a with the requester device 604a-both designated for context-aware transportation matching. Accordingly, as illustrated, the context-aware transportation matching system 106 prioritizes matching the provider device 602b with the requester device 604c—neither being designated for context-aware transportation matching—in order to allow for contextual matching between the provider device 602a and the requester device 604a. Indeed, in such implementations, the context-aware transportation matching system 106 can prioritize contextual transportation matches without detriment to generating non-contextual transportation matches.

The system can prioritize contextual transportation matches and/or non-contextual transportation matches in a variety of ways. For example, in some implementations, the context-aware transportation matching system 106 applies a score or weight in applying a transportation matching algorithm. For example, the context-aware transportation matching system 106 can apply a boost or weight in an optimization algorithm that places a greater priority on contextual transportation matches. In some implementations, the context-aware transportation matching system 106 applies a filter that only searches for matching devices that satisfy common contextual characteristics. In some embodiments, the context-aware transportation matching system 106 utilizes common contextual characteristics as features in a transportation matching algorithm (e.g., in a machine learning model trained to generate transportation matches).

As mentioned previously, in one or more embodiments, the context-aware transportation matching system 106 provides various graphical user interfaces enabling requesters and providers to accept and utilize the context-aware transportation matching in response to transportation requests. For example. FIGS. 7A-7C illustrate a series of graphical user interfaces for accepting prioritization of contextual transportation matches and submitting context-aware transportation requests. As shown in FIGS. 7A-7C, the context-aware transportation matching system 106 may provide graphical user interfaces 704a-704b, 708a-708b, and 712a-712b that can be displayed via a digital screen 702 of a client device 700 (e.g., a requester device or a provider device).

As shown in FIG. 7A, the context-aware transportation matching system 106 displays (or provides for display) the graphical user interface 704a on the digital screen 702 of the client device 700 (e.g., a requester device associated with the context-aware transportation matching system 106). As illustrated, the graphical user interface 704a includes a “Ride Preferences” menu by which a requester can select personal preferences for various features of the context-aware transportation matching system 106, such as “Ride Types” or “Contextual Preferences” for one or more contextual characteristics of the requester. Additionally, the context-aware transportation matching system 106 displays (or provides for display) the graphical user interface 704b (e.g., as a pop-up or overlaid menu) including a selectable option 706 for activating context-aware transportation matching. Accordingly, by interacting with the selectable option 706 within the graphical user interface 704b, a requester can opt to prioritize contextual transportation matches for transportation requests submitted using the client device 700 (or another requester device associated with the requester).

As shown in FIG. 7B, the context-aware transportation matching system 106 displays (or provides for display) the graphical user interface 708a on the digital screen 702 of the client device 700 (e.g., a provider device associated with the context-aware transportation matching system 106). As illustrated, the graphical user interface 708a includes a “Driving Preferences” menu by which a provider can select personal preferences for various features of the context-aware transportation matching system 106, such as “Location Filters” or “Contextual Preferences” for one or more contextual characteristics of the provider. Additionally, the context-aware transportation matching system 106 displays (or provides for display) the graphical user interface 708b (e.g., a pop-up or overlaid menu) including selectable options 710a and 710b for respectively activating or rejecting prioritization of contextual transportation matches with transportation requests.

As shown in FIG. 7C, the context-aware transportation matching system 106 displays (or provides for display) the graphical user interface 712a on the digital screen 702 of the client device 700 (e.g., a requester device associated with the context-aware transportation matching system 106). As illustrated, the graphical user interface includes a notification 714 indicating activation of context-aware transportation matching. Further, the context-aware transportation matching system 106 displays the graphical user interface 712b (e.g., a pop-up or overlaid menu) including an interactive menu by which the requester can configure and submit context-aware transportation requests to the context-aware transportation matching system 106.

Although FIGS. 7A-7C illustrate a particular graphical user interface flow, the context-aware transportation matching system 106 can utilize a variety of different approaches as described herein based on the embodiment of the context-aware transportation matching system 106. In some implementations, for example, the context-aware transportation matching system 106 allows the requestor device and/or the provider device to select the particular contextual features to prioritize in generate contextual transportation matches. For instance, the context-aware transportation matching system 106 can provide a plurality of contextual features elements (e.g., a gender element, a sports team element, etc.). Based on user interaction with one or more of the contextual feature elements the context-aware transportation matching system 106 can determine a contextual feature to utilize in generating contextual transportation matches.

In one or more embodiments, each of the components of the context-aware transportation matching system 106 are in communication with one another using any suitable communication technologies. Additionally, the components of the context-aware transportation matching system 106 can be in communication with one or more other devices including one or more client devices described above. Furthermore, although the components of FIGS. 1-7C are described in connection with the context-aware transportation matching system 106, at least some of the components for performing operations in conjunction with the context-aware transportation matching system 106 described herein may be implemented on other devices within the environment.

The components of the context-aware transportation matching system 106 can include software, hardware, or both. For example, the components of the context-aware transportation matching system 106 can include one or more instructions stored on a computer-readable storage medium and executable by processors of one or more computing devices. When executed by the one or more processors, the computer-executable instructions of the context-aware transportation matching system 106 can cause the computing device to perform the methods described herein. Alternatively, the components of the context-aware transportation matching system 106 can comprise hardware, such as a special purpose processing device to perform a certain function or group of functions. Additionally or alternatively, the components of the context-aware transportation matching system 106 can include a combination of computer-executable instructions and hardware.

Furthermore, the components of the context-aware transportation matching system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the context-aware transportation matching system 106 may be implemented as part of a stand-alone application on a personal computing device or a mobile device. Alternatively or additionally, the components of the context-aware transportation matching system 106 may be implemented in any application that allows creation and delivery of marketing content to users, including, but not limited to, various applications.

FIGS. 1-7C, the corresponding text, and the examples provide a number of different systems, methods, and non-transitory computer readable media for identifying contextual characteristics of requesters and/or providers and providing contextual transportation matches between requester devices and provider devices associated with respective requesters and providers sharing identified contextual characteristics. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for identifying contextual characteristics of a requester and providing a contextual transportation match to a requester device associated with the requester in accordance with one or more embodiments. As shown, the series of acts 800 includes an act 802 of determining contextual characteristic(s) of a requester, an act 804 of providing the requester with a selectable option to prioritize transportation matches with providers sharing the contextual characteristic(s), an act 806 of receiving a transportation request from a requester device associated with the requester, an act 808 of generating a contextual transportation match between the requester device and a provider device, and an act 810 of transmitting navigation instructions to the provider device to transport the requester device.

For example, in one or more implementations the acts 802-810 include: determining, utilizing a contextual characterization model, one or more contextual characteristics of a requester associated with a transportation matching system; providing, to the requester via a requester device, a selectable option to prioritize transportation matches with providers sharing the one or more contextual characteristics of the requester; receiving, at the transportation matching system, a transportation request from the requester device; generating, in response to receiving the transportation request and based on detecting interaction with the selectable option, a transportation match between the requester device and a provider device associated with a provider sharing the one or more contextual characteristics of the requester; and transmitting navigation instructions to the provider device to transport the requester device from a pickup location.

In one or more implementations, the series of acts 800 also includes determining, utilizing the contextual characterization model, the one or more contextual characteristics of the requester by identifying one or more of a geographical affiliation, an organizational affiliation, a gender identity, or a music preference of the requester. Further, in some embodiments, the series of acts 800 includes determining, utilizing the contextual characterization model, the one or more contextual characteristics of the requester by extracting information from a user profile associated with the requester and identifying the one or more contextual characteristics based on the extracted information.

Moreover, in one or more implementations, the series of acts 800 includes: determining, utilizing the contextual characterization model, one or more contextual characteristics of the provider; providing, to the provider via the provider device, an additional selectable option to prioritize transportation matches with requesters sharing the one or more contextual characteristics; determining, in response to receiving the transportation request and based on detecting interaction with the additional selectable option on the provider device, that the provider shares the one or more contextual characteristics of the requester; and generating, in response to determining that the provider shares the one or more contextual characteristics of the requester, the transportation match between the requester and the provider.

Also, in one or more implementations, the series of acts 800 includes generating the transportation match further based on determining that an ETA of the provider device to the pickup location is below a threshold ETA. Further, in some implementations, the series of acts 800 includes: determining an updated ETA of the provider device to the pickup location; generating, in response to determining that the updated ETA is above the threshold ETA, an updated transportation match between the requester device and an alternate provider device associated with an alternate provider; and transmitting updated navigation instructions to the alternate provider device to transport the requester device from the pickup location.

Furthermore, in one or more implementations, the series of acts 800 includes: receiving, at the transportation matching system, a plurality of additional transportation requests from a plurality of additional requester devices; identifying a subset of requester devices within the plurality of additional requester devices associated with a respective subset of requesters having the one or more contextual characteristics; and prioritizing transportation matches for the subset of requester devices with provider devices associated with providers identified as sharing the one or more contextual characteristics. Additionally, in some implementations, the series of acts 800 includes identifying a network imbalance within the transportation matching system and prioritizing, in response to identifying the network imbalance, transportation matches for requester devices other than the subset of requester devices with provider devices associated with providers other than the providers identified as sharing the one or more contextual characteristics.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the provider device(s) 122, the requester device(s) 112, or the server(s) 102) that may be configured to perform one or more of the processes described above. One will appreciate that the context-aware transportation matching system 106 can comprise implementations of the computing device 900, including, but not limited to, the provider device(s) 122 and/or the server(s) 102. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. The I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the transportation matching system 104. The network environment 1000 includes a client device 1006 (e.g., the provider device(s) 122 or the requester device(s) 112), a transportation matching system 104, and a vehicle subsystem 1008 connected to each other by a network 1004. Although FIG. 10 illustrates a particular arrangement of the client device 1006, the transportation matching system 104, the vehicle subsystem 1008, and the network 1004, this disclosure contemplates any suitable arrangement of client device 1006, the transportation matching system 104, the vehicle subsystem 1008, and the network 1004. As an example, and not by way of limitation, two or more of client device 1006, the transportation matching system 104, and the vehicle subsystem 1008 communicate directly, bypassing network 1004. As another example, two or more of client device 1006, the transportation matching system 104, and the vehicle subsystem 1008 may be physically or logically co-located with each other in whole or in part.

Moreover, although FIG. 10 illustrates a particular number of client devices 1006, transportation matching systems 104, vehicle subsystems 1008, and networks 1004, this disclosure contemplates any suitable number of client devices 1006, transportation matching system 104, vehicle subsystems 1008, and networks 1004. As an example, and not by way of limitation, network environment 1000 may include multiple client devices 1006, transportation matching system 104, vehicle subsystems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006, context-aware transportation matching system 106, and vehicle subsystem 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 104 may be a network-addressable computing system that can host a transportation matching network. The transportation matching system 104 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 104. In addition, the transportation matching system 104 may manage identities of service requesters such as users/requesters. In particular, the transportation matching system 104 may maintain requester data such as driving/riding histories, personal data, or other user data in addition to navigation and/or traffic management services or other location services (e.g., GPS services).

In particular embodiments, the transportation matching system 104 may manage transportation matching services to connect a user/requester with a vehicle and/or provider. By managing the transportation matching services, the transportation matching system 104 can manage the distribution and allocation of resources from vehicle systems and user resources such as GPS location and availability indicators, as described herein.

The transportation matching system 104 may be accessed by the other components of network environment 1000 either directly or via network 1004. In particular embodiments, the transportation matching system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or a transportation matching system 104 to manage, retrieve, modify, add, or delete, the information stored in data store.

In particular embodiments, the transportation matching system 104 may provide users with the ability to take actions on various types of items or objects, supported by the transportation matching system 104. As an example, and not by way of limitation, the items and objects may include transportation matching networks to which users of the transportation matching system 104 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 104 or by an external system of a third-party system, which is separate from transportation matching system 104 and coupled to the transportation matching system 104 via a network 1004.

In particular embodiments, the transportation matching system 104 may be capable of linking a variety of entities. As an example, and not by way of limitation, the transportation matching system 104 may enable users to interact with each other or other entities, or to allow users to interact with these entities through an application programming interfaces (“API”) or other communication channels.

In particular embodiments, the transportation matching system 104 may include a variety of servers, sub-systems, programs, modules, logs, and data stores. In particular embodiments, the transportation matching system 104 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. The transportation matching system 104 may also include suitable components such as network interfaces, security mechanisms, load balancers, failover servers, management-and-network-operations consoles, other suitable components, or any suitable combination thereof. In particular embodiments, the transportation matching system 104 may include one or more user-profile stores for storing user profiles for transportation providers and/or transportation requesters. A user profile may include, for example, biographic information, demographic information, behavioral information, social information, or other types of descriptive information, such as interests, affinities, or location.

The web server may include a mail server or other messaging functionality for receiving and routing messages between the transportation matching system 104 and one or more client devices 1006. An action logger may be used to receive communications from a web server about a user's actions on or off the transportation matching system 104. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the transportation matching system 104. A privacy setting of a user determines how particular information associated with a user can be shared. The authorization server may allow users to opt in to or opt out of having their actions logged by the transportation matching system 104 or shared with other systems, such as, for example, by setting appropriate privacy settings. Third-party-content-object stores may be used to store content objects received from third parties. Location stores may be used for storing location information received from client devices 1006 associated with users.

In addition, the vehicle subsystem 1008 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1008 can include an autonomous vehicle—e.g., a vehicle that does not require a human operator. In these embodiments, the vehicle subsystem 1008 can perform maneuvers, communicate, and otherwise function without the aid of a human provider, in accordance with available technology.

In particular embodiments, the vehicle subsystem 1008 may include one or more sensors incorporated therein or associated thereto. For example, sensor(s) can be mounted on the top of the vehicle subsystem 1008 or else can be located within the interior of the vehicle subsystem 1008. In certain embodiments, the sensor(s) can be located in multiple areas at once—e.g., split up throughout the vehicle subsystem 1008 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1008 may include a communication device capable of communicating with the client device 1006 and/or the context-aware transportation matching system 106. For example, the vehicle subsystem 1008 can include an on-board computing device communicatively linked to the network 1004 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining, utilizing a contextual characterization model, one or more contextual characteristics of a requester associated with a transportation matching system;
providing, to the requester via a requester device, a selectable option to prioritize transportation matches with providers sharing the one or more contextual characteristics of the requester;
receiving, at the transportation matching system, a transportation request from the requester device;
generating, in response to receiving the transportation request and based on detecting interaction with the selectable option, a transportation match between the requester device and a provider device associated with a provider sharing the one or more contextual characteristics of the requester; and
transmitting navigation instructions to the provider device to transport the requester device from a pickup location.

2. The computer-implemented method of claim 1, wherein determining, utilizing the contextual characterization model, the one or more contextual characteristics of the requester comprises identifying one or more of a geographical affiliation, an organizational affiliation, a gender identity, or a music preference of the requester.

3. The computer-implemented method of claim 1, wherein determining, utilizing the contextual characterization model, the one or more contextual characteristics of the requester comprises:
extracting information from a user profile associated with the requester; and
identifying the one or more contextual characteristics based on the extracted information.

4. The computer-implemented method of claim 1, further comprising:
determining, utilizing the contextual characterization model, one or more contextual characteristics of the provider;
providing, to the provider via the provider device, an additional selectable option to prioritize transportation matches with requesters sharing the one or more contextual characteristics;
determining, in response to receiving the transportation request and based on detecting interaction with the additional selectable option on the provider device, that the provider shares the one or more contextual characteristics of the requester; and
generating, in response to determining that the provider shares the one or more contextual characteristics of the requester, the transportation match between the requester and the provider.

5. The computer-implemented method of claim 1, wherein generating the transportation match is further based on determining that an ETA of the provider device to the pickup location is below a threshold ETA.

6. The computer-implemented method of claim 5, further comprising:
determining an updated ETA of the provider device to the pickup location;
generating, in response to determining that the updated ETA is above the threshold ETA, an updated transportation match between the requester device and an alternate provider device associated with an alternate provider; and
transmitting updated navigation instructions to the alternate provider device to transport the requester device from the pickup location.

7. The computer-implemented method of claim 1, further comprising:
receiving, at the transportation matching system, a plurality of additional transportation requests from a plurality of additional requester devices;
identifying a subset of requester devices within the plurality of additional requester devices associated with a respective subset of requesters having the one or more contextual characteristics; and
prioritizing transportation matches for the subset of requester devices with provider devices associated with providers identified as sharing the one or more contextual characteristics.

8. The computer-implemented method of claim 7, further comprising:
identifying a network imbalance within the transportation matching system; and
prioritizing, in response to identifying the network imbalance, transportation matches for requester devices other than the subset of requester devices with provider devices associated with providers other than the providers identified as sharing the one or more contextual characteristics.

9. A system comprising:
at least one processor; and
a non-transitory computer readable storage medium comprising instructions that, when executed by the at least one processor, cause the system to:
determine, utilizing a contextual characterization model, one or more contextual characteristics of a requester associated with a transportation matching system;
provide, to the requester via a client device, a selectable option to prioritize transportation matches with providers sharing the one or more contextual characteristics of the requester;
receive, at the transportation matching system, a transportation request from a requester device associated with the requester;
generate, in response to receiving the transportation request and based on detecting interaction with the selectable option, a transportation match between the requester and a provider sharing the one or more contextual characteristics of the requester; and
transmit navigation instructions to a provider device associated with the provider to transport the requester from a pickup location.

10. The system of claim 9, further comprising instructions that, when executed by the at least one processor, cause the system to determine, utilizing the contextual characterization model, the one or more contextual characteristics of the requester by:
extracting information from a user profile associated with the requester; and
identifying the one or more contextual characteristics based on the extracted information.

11. The system of claim 9, further comprising instructions that, when executed by the at least one processor, cause the system to:
determine, utilizing the contextual characterization model, one or more contextual characteristics of the provider;
provide, to the provider via the provider device, an additional selectable option to prioritize transportation matches with requesters sharing the one or more contextual characteristics of the provider;
determine, in response to receiving the transportation request and based on detecting interaction with the additional selectable option on the provider device, that the provider shares the one or more contextual characteristics of the requester; and
generate, in response to determining that the provider shares the one or more contextual characteristics of the requester, the transportation match between the requester and the provider.

12. The system of claim 9, further comprising instructions that, when executed by the at least one processor, cause the system to generate the transportation match based on determining that an ETA of the provider device to the pickup location is below a threshold ETA.

13. The system of claim 12, further comprising instructions that, when executed by the at least one processor, cause the system to:
determine an updated ETA of the provider device to the pickup location;
generate, in response to determining that the updated ETA is above the threshold ETA, an updated transportation match between the requester device and an alternate provider device associated with an alternate provider; and
transmit updated navigation instructions to the alternate provider device to transport the requester device from the pickup location.

14. The system of claim 9, further comprising instructions that, when executed by the at least one processor, cause the system to:
receive, at the transportation matching system, a plurality of additional transportation requests from a plurality of additional requester devices;
identify a subset of requester devices within the plurality of additional requester devices associated with a respective subset of requesters having the one or more contextual characteristics; and
prioritize transportation matches for the subset of requester devices with provider devices associated with providers identified as sharing the one or more contextual characteristics.

15. The system of claim 14, further comprising instructions that, when executed by the at least one processor, cause the system to:
identifying a network imbalance within the transportation matching system; and
prioritizing, in response to identifying the network imbalance, transportation matches for requester devices other than the subset of requester devices with provider devices associated with providers other than the providers identified as sharing the one or more contextual characteristics.

16. A non-transitory computer readable storage medium comprising instructions that, when executed by at least one processor, cause the at least one processor to:
determine, utilizing a contextual characterization model, one or more contextual characteristics of a requester associated with a transportation matching system;
provide, to the requester via a client device, a selectable option to prioritize transportation matches with providers sharing the one or more contextual characteristics of the requester;
receive, at the transportation matching system, a transportation request from a requester device associated with the requester;
generate, in response to receiving the transportation request and based on detecting interaction with the selectable option, a transportation match between the requester and a provider sharing the one or more contextual characteristics of the requester; and
transmit navigation instructions to a provider device associated with the provider to transport the requester from a pickup location.

17. The non-transitory computer readable storage medium of claim 16, further comprising instructions that, when executed by the at least one processor, cause the at least one processor to determine, utilizing the contextual characterization model, the one or more contextual characteristics of the requester by identifying one or more of a geographical affiliation, an organizational affiliation, a gender, or a music preference of the requester.

18. The non-transitory computer readable storage medium of claim 16, further comprising instructions that, when executed by the at least one processor, cause the at least one processor to determine, utilizing the contextual characterization model, the one or more contextual characteristics of the requester by:
extracting information from a user profile associated with the requester; and
identifying the one or more contextual characteristics based on the extracted information.

19. The non-transitory computer readable storage medium of claim 16, further comprising instructions that, when executed by the at least one processor, cause the at least one processor to:
determine, utilizing the contextual characterization model, one or more contextual characteristics of the provider;
provide, to the provider via the provider device, an additional selectable option to prioritize transportation matches with requesters sharing the one or more contextual characteristics of the provider;
determine, in response to receiving the transportation request and based on detecting interaction with the additional selectable option on the provider device, that the provider shares the one or more contextual characteristics of the requester; and
generate, in response to determining that the provider shares the one or more contextual characteristics of the requester, the transportation match between the requester and the provider.

20. The non-transitory computer readable storage medium of claim 16, further comprising instructions that, when executed by the at least one processor, cause the at least one processor to generate the transportation match based on determining that an ETA of the provider device to the pickup location is below a threshold ETA.
